(19) United States
(12) Patent Application Publication
(10) Pub. No.: US 2010/0238097 A1
(43) Pub. Date: Sep. 23, 2010

(54) 2-D and 3-D switchalbe and multi-full size image dispaly system

(76) Inventors: In-Su Baik, Paju-si (KR); Su-Dong Roh, Annyang-si (KR)

Correspondence Address: MCKENNA LONG & ALDRIDGE LLP, 1900 K STREET, NW, WASHINGTON, DC, 20006, US

(21) Appl. No.: 12/458,960

(22) Filed: Jul. 28, 2009

(30) Foreign Application Priority Data
Mar. 20, 2009 (KR) 10-2009-0023888

(51) Int. Cl. G09G 3/36

(52) U.S. Cl. 345/87

(57) ABSTRACT

An image display system includes a display device including a (2N−1)th pixel row and a (2N)th pixel row and producing a first image on the (2N−1)th pixel row and a second image on the (2N)th pixel row, wherein N is positive integer; a patterned retarder at an outer side of the display device and including a first pattern corresponding to the (2N−1)th pixel row and a second pattern corresponding to the (2N) pixel row, wherein a light of the first image is polarized as a first polarized light by the first pattern and a light of the second image is polarized as a second polarized light by the second pattern; a first polarization film on one of lenses of a glasses and transmitting one of the first and second polarized lights; and a second polarization film on the other one of the lenses of the glasses and transmitting the other one of the first and second polarized lights.

The present application claims the benefit of Korean Patent Application No. 10-2009-0023888 filed in Korea on Mar. 20, 2009, which is hereby incorporated by reference.

### BACKGROUND OF THE INVENTION

1. Field of the Invention

The present invention relates to an image display system, and more particularly, to an image display device that is able to display multiple images with a full screen size and switch from a two dimensional (2-D) mode into a three dimensional (3-D) mode or from the 3-D mode into the 2-D mode.

2. Discussion of the Related Art

Generally, the liquid crystal display (LCD) devices drives liquid crystal molecules in a liquid crystal layer using an electric field induced between two electrodes. The LCD device uses optical anisotropy and polarization properties of liquid crystal molecules. The liquid crystal molecules have a definite alignment direction as a result of their thin and long shapes. The LCD device includes a liquid crystal panel as an essential element. The liquid crystal panel includes a pair of substrates. On each of the substrates, first and second electrodes are formed to generate an electric field. The alignment direction of the liquid crystal molecules can be controlled by application of the electric field across the liquid crystal molecules. As the intensity or direction of the electric field is changed, the alignment of the liquid crystal molecules also changes. Since incident light is refracted based on the orientation of the liquid crystal molecules due to the optical anisotropy of the liquid crystal molecules, two dimensional (2-D) images can be displayed by controlling light transmissivity.

Recently, an LCD device being capable of displaying three dimensional (3-D) images is introduced. A technology of producing the 3-D images including 3-D stereoscopic images from two dimensional (2-D) images can be used in display technologies, aerospace technologies, etc. The technology using ripple effects to produce 3-D images can not only be used in applications for high definition televisions (HDTV), but also can be used in a variety of other applications.

The technology of producing 3-D stereoscopic images includes a volumetric type, a holographic type, and stereoscopic type. The volumetric type uses psychological illusions to create illusory perception along a depth direction. When observers receive 3-D computer graphical images on a large screen having a wide view angle, the observers can experience viewing an optical illusion. By calculating and implementing various factors in 3-D computer graphics technology, images can be displayed to give the observers a 3-D effect on movement, brightness, shade, etc. An example of this kind of volumetric type of display is an IMAX™ movie. In an IMAX™ movie, two camera lenses are used to represent images for the left and right eyes. The two lenses are separated by an average distance between a human's eyes. By recording images on two separate rolls of film for the left and right eyes, and then projecting them simultaneously, the viewers can be tricked into seeing a 3D image on a 2D screen. The holographic type is known to be the most remarkable technology for displaying 3-D stereoscopic images. The holographic type can be further divided depending on the light source that is used. For example, there are holographic displays using laser and holographic displays using white light. The stereoscopic type uses psychological effects to create 3-D images. In normal vision, human eyes perceive views of the world from two different perspectives due to the spatial separation of two eyes. The spatial separation between typical eyes is about 65 mm. In order to assess the distance between objects, the brain integrates the two images obtained from each eye. By integrating two images, we are able to perceive 3-D images. The above method of perceiving a 3-D image is referred to as a stereography phenomenon. The stereoscopic type can be divided into a glasses type and a glasses-free type depending on whether glasses are adopted. The glasses-free type uses a parallax barrier, a lenticular lens array, or an integral lens array, etc. Among these devices, the lenticular lens array is widely under research today since observers can see 3-D images simply by disposing a lenticular lens on a display panel without any other equipment.

Recently, a display device being capable of displaying at least two images in one screen is introduced. It may be called as a picture in picture (PIP) type display device. Since the PTP type display device produces at least two different images on one screen at the same time, at least two users can watch different desired images.

FIG. 1 is a schematic view illustrating the related art PIP type display device. As shown in FIG. 1, one screen of the PIP type display device is divided into a major picture A and a minor image B. Unfortunately, there are some problems.

The major picture A is larger than the minor image B such that user watching the minor image B can not watch a picture of a desired size. In addition, a part of the major picture A is shield by the s minor image B such that one user watching the major picture A can not watch all picture. Moreover, when one user wants to watch a secret document from a computer on a screen and another user wants to watch a TV program on the same screen, the major and minor images A and B are displayed on the same screen such that a private life can not be protected.

### SUMMARY OF THE INVENTION

Accordingly, the present invention is directed to a lenticular lens array and image display device including the same that substantially obviates one or more problems due to limitations and disadvantages of the related art.

An object of the present invention is to provide an image display device that easily converts a 2-D mode into a 3-D mode and a 3-D mode into a 2-D mode with low power consumption.

Another object of the present invention is to provide an image display device that displays multiple images with a full screen size.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an image display system includes a display device including a (2N−1)th pixel row and a (2N)th pixel row and producing a first image on the (2N−1)th pixel row and a second image on the (2N)th pixel row, wherein N is positive integer; a patterned retarder at an outer side of the display device and including a first pattern corresponding to the (2N−1)th pixel row and a second pattern corresponding to the (2N) pixel row, wherein a light of the first image is polarized as a first polarized light by the first pattern and a light of the second image is polarized as a second polarized light by the second pattern; a first polarization film on one of lenses of a glasses and transmitting one of the first and second polarized lights; and a second polarization film on the other one of the lenses of the glasses and transmitting the other one of the first and second polarized lights.

In another aspect, an image display system includes a display device including a (2N−1)th pixel row and a (2N)th pixel row and producing a first image on the (2N−1)th pixel row and a second image on the (2N)th pixel row, wherein N is positive integer; a patterned retarder at an outer side of the display device and including a first pattern corresponding to the (2N−1)th pixel row and a second pattern corresponding to the (2N)th pixel row, wherein a light of the first image is polarized as a first polarized light by the first pattern and a light of the second image is polarized as a second polarized light by the second pattern; a first polarization film on both lenses of a first glasses and transmitting one of the first and second polarized lights; and a second polarization film on both lenses of a second glasses and transmitting the other one of the first and second polarized lights.

In yet another aspect, an image display system includes a display device producing first to Nth images during first to Nth frames, respectively, wherein N is a positive integer; a polarization modulation panel at an outer side of the display device, a condition of the polarization modulation panel is changed in each frame such that lights of the first to Nth images are changed to be first to Nth polarized lights by the polarization modulation panel; first to Nth polarization films attached on first to Nth glasses, respectively.

In yet another aspect, an image display system includes a display device producing first and second images during first and second frames, respectively; a polarization modulation panel at an outer side of the display device, a condition of the polarization modulation panel is changed in each frame such that lights of the first and second images are polarized as first and second polarized lights by the polarization modulation panel, respectively; a first polarization film on one of lenses of a glasses and transmitting one of the first and second polarized lights; and a second polarization film on the other one of the lenses of the glasses and transmitting the other one of the first and second polarized lights.

In yet another aspect, an image display system includes a display device producing first and second images during first and second frames, respectively; a first shutter lens at one side of a glasses, the first shutter being opened during the first frame and being closed during the second frame; and a second shutter lens at the other one side of the glasses, the second shutter being closed during the first frame and being opened during the second frame.

In yet another aspect, an image display system includes a display device producing first and second images during first and second frames, respectively; a first shutter lens at both sides of a first glasses, the first shutter being opened during the first frame and being closed during the second frame; and a second shutter lens at both sides of a second glasses, the second shutter being closed during the first frame and being opened during the second frame.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic view illustrating the related art PIP type display device;

FIG. 2 is a schematic view illustrating an image display device in a 3-D mode according to a first embodiment of the present invention;

FIG. 3 is a schematic view illustrating an image display device producing multiple 2-D images on a full screen sized according to a first embodiment of the present invention;

FIG. 4 is a schematic view illustrating an image display device producing multiple 2-D images on a full screen sized according to a second embodiment of the present invention;

FIG. 5 is a schematic view illustrating an image display device in a 3-D mode according to a third embodiment of the present invention; and

FIG. 6 is a schematic view illustrating an image display device producing multiple 2-D images on a full screen sized according to a third embodiment of the present invention.

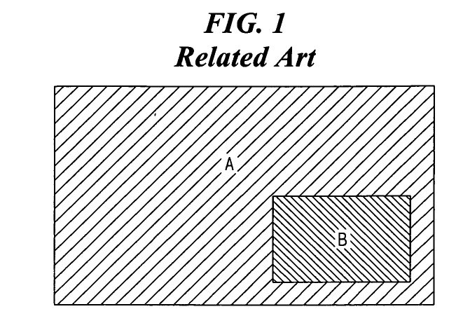

### DETAILED DESCRIPTION OF THE PREFERRED EMBODIMENTS

Reference will now be made in detail to the preferred embodiments of the present invention, examples of which are illustrated in the accompanying drawings.

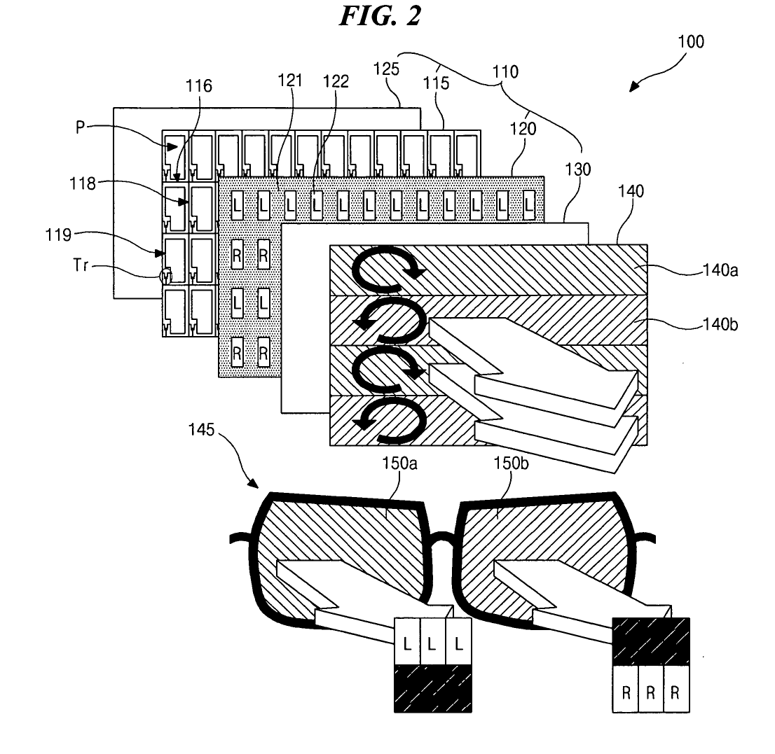

FIG. 2 is a schematic view illustrating an image display device in a 3-D mode according to a first embodiment of the present invention. In FIG. 2, an image display system 100 includes a liquid crystal display (LCD) device 110 for producing images (or lights), a patterned retarder 140 at an outer side of the LCD device 110 and a glass 145 for selectively transmitting images through the patterned retarder 140.

The LCD device 110 includes an array substrate 115, a color filter substrate 120, a liquid crystal (LC) layer (not shown), first and second polarizing plates 125 and 130, and a backlight unit (not shown). The array substrate 115 and the color filter substrate 120 face to each other. The LC layer is interposed between the array substrate 115 and the color filter substrate 120. The first and second polarizing plates 125 and 130 are disposed at an outer side of the array substrate 115 and the color filter substrate 120, respectively. The backlight unit is disposed at an outer side of the first polarizing plate 125. Namely, the first polarizing plate 125 is positioned between the array substrate 115 and the backlight unit.

In the array substrate 115, a gate line 116 and a data line 118 cross each other such that a pixel region P is defined on a first substrate (not shown). A thin film transistor (TFT) Tr connected to the gate and data lines 116 and 118 is disposed in each pixel region P. A pixel electrode 119 in each pixel region P is connected to the TFT Tr.

On the color filter substrate 120, a black matrix 121 is formed to corresponding to a boundary of the pixel region P. A color filter layer 122 including red, green and blue color filter patterns is formed to corresponding to each pixel region P. A common electrode (not shown) is formed on the color filter layer 122. The LC molecules in the LC layer are driven by a vertical electric field between pixel electrode 119 and the common electrode. Alternatively, the common electrode may be formed on the first substrate with the pixel electrode. In this case, the common electrode is alternately arranged with the pixel electrode such that the LC molecules in the LC layer are driven by a horizontal electric field between pixel electrode and the common electrode. A fist image for a left-side eye is displayed on (2N−1)th row pixel regions L, while a second image for a right-side eye is displayed on (2N)th row pixel regions R. N is a positive integer.

A polarization axis of the first polarizing plate 125 may be perpendicular to that of the second polarizing plate 130. The backlight unit provides light onto the array substrate 115 through the first polarizing plate 125 such that a 2-D image is displayed by driving the LC layer.

The patterned retarder 140 is disposed at an outer side of the second polarizing plate 130. Namely, the second polarizing plate 130 is positioned between the color filter substrate 120 and the patterned retarder 140. The patterned retarder 140 includes a first pattern 140a in a (2N−1)th row and a second pattern 140b in a (2N)th row. The first and second patterns 140a and 140b correspond to (2N−1)th row pixel regions L and (2N)th row pixel regions R of the LCD device 110, respectively. The first and second patterns 140a and 140b have different properties. For example, the light from the (2N−1)th row pixel regions L through the second polarizing plate 130 is changed into a right-hand circularly polarized light by the first pattern 140a of the patterned retarder 140, while the light from the (2N)th row pixel regions R through the second polarizing plate 130 is changed into a left-hand circularly polarized light by the second pattern 140b of the patterned retarder 140. Alternatively, the light from the (2N−1)th row pixel regions L through the second polarizing plate 130 is changed into a left-hand circularly polarized light by the first pattern 140a of the patterned retarder 140, while the light from the (2N)th row pixel regions R through the second polarizing plate 130 is changed into a right-hand circularly polarized light by the second pattern 140b of the patterned retarder 140. Namely, the first and second patterns 140a and 140b are formed of materials differently changing a phase difference. A position of the first and second patterns 140a and 140b can be replaced by each other.

Different types polarizing films are attached on the glass 145. A first polarizing film 150a for selectively transmitting a right-hand circularly polarized light is attached on a left-side lens of the glass 145. A second polarizing film 150b for selectively transmitting a left-hand circularly polarized light is attached on a right-side lens of the glass 145.

As mentioned above, the (2N−1)th row pixel regions L of the LCD device 110 provide the first image for the left-side eye, and the (2N)th row pixel region R of the LCD device 110 provide the second image for the right-side eye. In addition, the light from the (2N−1)th row pixel regions L through the second polarizing plate 130 is changed into a right-hand circularly polarized light by the first pattern 140a of the patterned retarder 140, while the light from the (2N)th row pixel regions R through the second polarizing plate 130 is changed into a left-hand circularly polarized light by the second pattern 140b of the patterned retarder 140. As a result, the user wearing the glass 145 receives the first image for the left-side eye from the (2N−1)th row pixel regions L, which is changed into the right-hand circularly polarized light, on the left-side eye through the left-side lens of the glass 140 and the second image for the right-side eye from the (2N−1)th row pixel regions R, which is changed into the left-hand circularly polarized light, on the left right through the right-side lens of the glass 140. The first and second images are combined such that the user can watch a 3-D image.

FIG. 2 shows the glass 145 where the first polarizing film 150a, which selectively transmits the right-hand circularly polarized light, is attached on the left-side lens and the second polarizing film 150b, which selectively transmits the left-hand circularly polarized light, is attached on the right-side lens. However, a position of the first and second polarizing films 150a and 150b may be replaced by each other. Namely, the first polarizing film 150a, which selectively transmits the right-hand circularly polarized light, is attached on the right-side lens, and the second polarizing film 150b, which selectively transmits the left-hand circularly polarized light, is attached on the left-side lens.

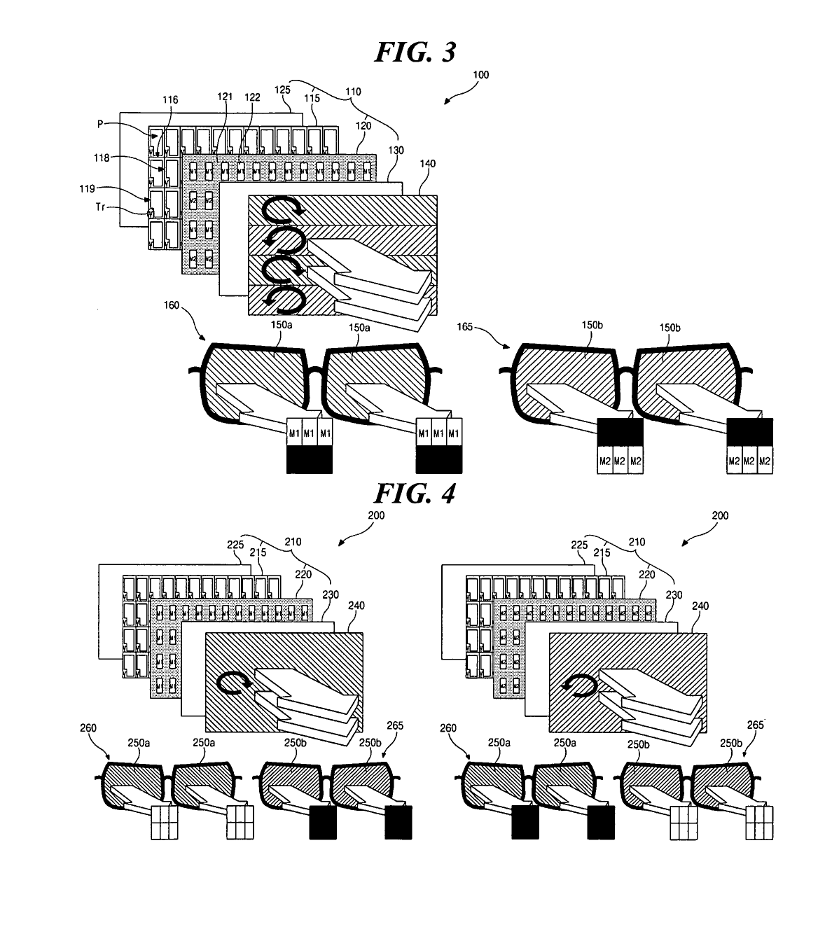

FIG. 2 shows the image display system 100 displaying the 3-D image. Alternatively, the image display system can display a main picture of a 2-D image and a second image of a 2-D image. Both the main and second images are displayed on a full screen size with one display device. This feature is illustrated with FIG. 3. FIG. 3 is a schematic view illustrating an image display device producing multiple 2-D images on a full screen sized according to a first embodiment of the present invention.

In FIG. 3, an image display system 100 includes a liquid crystal display (LCD) device 110 for producing images, a patterned retarder 140 at an outer side of the LCD device 110, a first glass 160 and a second glass 165. A first polarizing film 150a is attached on both a left-side lens and a right-side lens of the first glass 160. A second polarizing film 150b is attached on both a left-side lens and a right-side lens of the second glass 165.

The LCD device 100 has substantially the same structure as that of FIG. 2. As mentioned above, in the LCD device 100 of FIG. 2, the fist image for the left-side eye is displayed on the (2N−1)th row pixel regions L, and the second image for the right-side eye is displayed on the (2N)th row pixel regions R. However, in the LCD device 100 of FIG. 3, a first image for a first user is displayed on (2N−1)th row pixel regions M1, while a second image for a second user is displayed on (2N)th row pixel regions M2. The first and second polarizing plates 125 and 130 and the backlight unit also has the same relations with other elements as described above.

In addition, the patterned retarder 140 has the same structure and function as that of FIG. 2. Namely, the light from the (2N−1)th row pixel regions M1 through the second polarizing plate 130 is changed into a right-hand circularly polarized light by the first pattern 140a of the patterned retarder 140, while the light from the (2N)th row pixel regions M2 through the second polarizing plate 130 is changed into a left-hand circularly polarized light by the second pattern 140b of the patterned retarder 140. Alternatively, the light from the (2N−1)th row pixel regions L through the second polarizing plate 130 is changed into a left-hand circularly polarized light by the first pattern 140a of the patterned retarder 140, while the light from the (2N)th row pixel regions R through the second polarizing plate 130 is changed into a right-hand circularly polarized light by the second pattern 140b of the patterned retarder 140.

As mentioned above, the first polarizing film 150a is attached on the left-side and right-side lens of the first glass 160, and the second polarizing film 150b, which has a different property from the first polarizing film 150a, is attached on the left-side and right-side lens of the second glass 165. For example, the fist polarizing film 150a on the first glass 160 only transmits the right-hand circularly polarized light, while the second polarizing film 150b on the second glass 165 only transmits the left-hand circularly polarized light. Alternatively, the fist polarizing film 150a on the first glass 160 only transmits the left-hand circularly polarized light, while the second fist polarizing film 150b on the second glass 165 only transmits the right-hand circularly polarized light.

By the image display system including the LCD device 100, the first glasses 160 and the second glasses 165, and so on, the first user can watch the main picture of the 2-D mode with a full screen size, and the second user can watch the second image of the 2-D mode with a full screen size. In the related art PIP mode display device, a part of the first image is shielded by the second image, and the second image is displayed with a smaller size than the second image. However, in the present invention, both the first and second images are displayed on a full screen with one display device.

In FIGS. 2 and 3, the light is changed into the right-hand circularly polarized light and the left-hand circularly polarized light by the patterned retarder 140. However, the light may be changed into another type. For example, by the patterned retarder 140, the light from the (2N−1)th row pixel regions is changed into a first linear polarized light, and the light from the (2N)th row pixel regions is changed into a second linear polarized light different from the first linear polarized light. The first linear polarized light may be polarized by 45, 90 or 135 degrees. In the 3-D mode image display device of FIG. 2, the first polarizing film 150a on the left-side lens of the glass 145 only transmits the first linear polarized light, and the second polarizing film 150b on the right-side lens of the glass 145 only transmits the second linear polarized light. As a result, the user can watch the 3-D image with the glass 145.

On the other hand, in the 2-D mode image display device of FIG. 3, the first polarizing film 150a on both the left-side and right-side lenses of the first glass 160 only transmits the first linear polarized light, and the second polarizing film 150b both the left-side and right-side lenses of the second glass 160 only transmits the second linear polarized light. As a result, the first user can watch the first image of the 2-D mode with the first glass 160, and the second user can watch the second image of the 2-D mode with the second glass 165.

Consequently, the light from the (2N−1)th row pixel regions is changed into a first polarized light having a first polarized condition by the first pattern of the patterned retarder, and the light from the (2N)th row pixel regions is changed into a second polarized light having a second polarized condition, which is different from the first polarized condition, by the second pattern of the patterned retarder. In the 3-D mode display device, one of the right-side and left-sides lenses only transmits one of the first and second polarized lights, and the other one of the right-side and left-sides lenses only transmits the other one of the first and second polarized lights. In the 2-D mode display device, one of the first glasses and the second glasses only transmits one of the first and second polarized lights, and the other one of the first glasses and the second glasses only transmits the other one of the first and second polarized lights.

FIG. 4 is a schematic view illustrating an image display device according to a second embodiment of the present invention. In FIG. 4, an image display device 200 includes an LCD device 210 for producing images, a polarization modulation panel 240 at an outer side of the LCD device 210 and first glasses 260 and the second glasses 265. Similarly to the device of FIG. 3, a first polarizing film 250a is attached on both a left-side lens and a right-side lens of the first glass 260. A second polarizing film 250b is attached on both a left-side lens and a right-side lens of the second glass 265.

The LCD device 200 has substantially the same structure as that of FIG. 3. However, there are some differences. The LCD device 200 produces a first image for a first user during a (2N−1)th frame and a second image for a second user during a (2N)th frame. Each of the frames has a period within several milliseconds. A polarization condition of light from the LCD device 210 is changed by the polarization modulation panel 240. Although not shown, the polarization modulation panel 240 includes first and second substrates and a liquid crystal layer therebetween. A first electrode is formed on the first substrate of the polarization modulation panel 240, and a second electrode is formed on the second substrate of the polarization modulation panel 240. The alignment direction of the liquid crystal molecules in the liquid crystal layer of the polarization modulation panel 240 can be controlled by an electric field, which is induced between first and second electrodes of the polarization modulation panel 240, across the liquid crystal molecules. As a result, the liquid crystal molecules are arranged along a first direction in the (2N−1)th frame such that the light is changed to have a first polarization condition by the polarization modulation panel 240. Meanwhile, the liquid crystal molecules are arranged along a second direction, which is different from the first direction, in the (2N)th frame such that the light is changed to have a second polarization condition, which is different from the first polarization condition, by the polarization modulation panel 240. Accordingly, the light is modulated by the polarization modulation panel 240 to have the first polarization condition during the (2N−1)th frame and the light is modulated by the polarization modulation panel 240 to have the second polarization condition during the (2N)th frame. For example, the light in the (2N01)th frame may be changed to be a right-hand circularly polarized light by the polarization modulation panel 240, and the light in the (2N)th frame may be changed to be a left-hand circularly polarized light by the polarization modulation panel 240.

As mentioned above, the first polarizing film 250a is attached on the left-side and right-side lens of the first glass 260, and the second polarizing film 250b, which has a different property from the first polarizing film 250a, is attached on the left-side and right-side lens of the second glass 265. For example, the fist polarizing film 250a on the first glass 260 only transmits the light having the first polarization condition, while the second polarizing film 250b on the second glass 265 only transmits the light having the second polarization condition. The first user wearing the first glass 260 can watch the first image of a 2-D mode with a full screen size, and the second user wearing the second glass 265 can watch the second image of a 2-D mode with the full screen size.

In the second embodiment, the first and second users can watch the first and second images with the full screen size, respectively. If there is a requirement for at least three images, the LCD device 210 produces at least three images and the lights from the LCD device 210 is modulated by the polarization modulation panel 240 to have different polarization conditions. For example, three users can watch first to third images with first to third glasses, respectively. Accordingly, in the second embodiment, even if a number of the images are increased, there is no problem. Namely, first to Nth users can watch first to Nth images with a full screen size. When the image is flickered at least thirty times per one second, the human can not perceive the flickering. Accordingly, the LCD device is generally driven in a 60 Hz mode. (each frame has a period of 1/60 second) When the LCD device 210 with the 60 Hz mode produce the first and second images during the (2N−1)th and (2N)th frames, respectively, each frame is repeated thirty times such that the user can not perceive the flickering. As a result, each image is provided with a desired image quality.

When the LCD device 210 is driven in a 120 Hz mode, four images can be provided for four users. In this case, the polarization modulation panel 240 repeatedly modulates the lights from the LCD device 210 to have first to fourth polarization conditions. The first to fourth users wearing the first to fourth glasses, where the first to fourth polarization films are attached, can watch the first to fourth images with a full screen size with a desired image quality. Similarly, when the LCD device 210 is driven in a 240 Hz mode, eight images can be provided for eight users. In this case, the polarization modulation panel 240 repeatedly modulates the lights from the LCD device 210 to have first to eighth polarization conditions. The first to eighth users wearing the first to eight glasses, where the first to eighth polarization films are attached, can watch the first to eighth images with a full screen size with a desired image quality. Similarly, when the LCD device 210 is driven in a (60*N/2) Hz mode, N images can be provided for N users. In this case, the polarization modulation panel 240 repeatedly modulates the lights from the LCD device 210 to have first to Nth polarization conditions. The first to Nth users wearing the first to Nth glasses, where the first to Nth polarization films are attached, can watch the first to Nth images with a full screen size with a desired image quality.

Although not shown, when the user can watch a 3-D image with a glass where different type polarization films are attached on the left-side and right-side lenses. For the 3-D image, a glass, on left-side and right-side lenses of which different type polarization films are respectively attached, is required. Referring to FIG. 4, the LCD device 210 produces a first image for a left-side eye during a (2N−1)th frame and a second image for a right eye user during a (2N)th frame. Each of the frames has a period within several milliseconds. The light from the LCD device 210 is modulated by the polarization modulation panel 240 to have the first polarization condition during the (2N−1)th frame and the light from the LCD device 210 is modulated by the polarization modulation panel 240 to have the second polarization condition during the (2N)th frame. With the LCD device 210 and the polarization modulation panel 240, the left-side of the glass, where a first polarization film is attached, only transmits the light having the first polarization condition, and the right-side of the glass, where a second polarization film is attached, only transmits the light having the second polarized condition. Since each of the (2N−1)th and (2N)th frames has a period within several milliseconds, the user feels to receive the first and second images at the same time such that the user can perceive a 3-D image by integrating the first and second images.

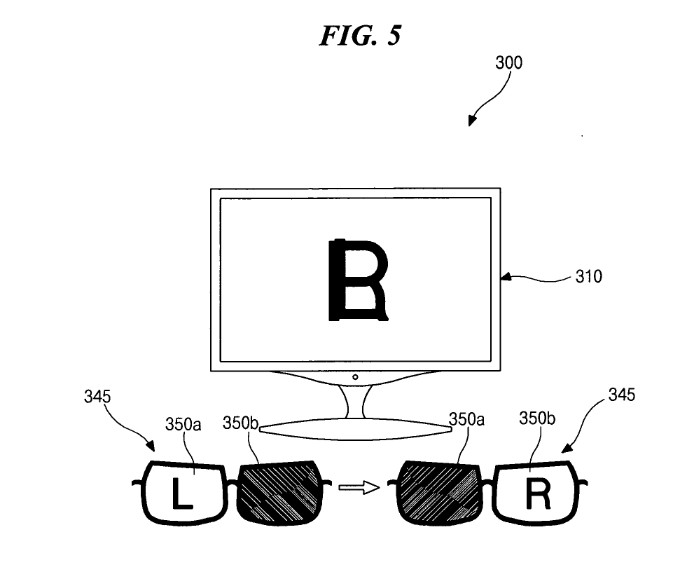

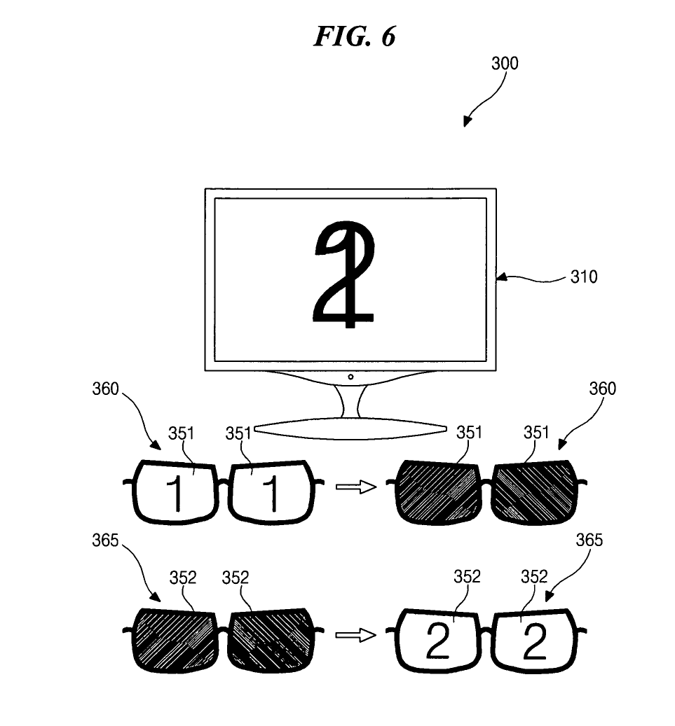

FIG. 5 is a schematic view illustrating an image display device in a 3-D mode according to a third embodiment of the present invention, FIG. 6 is a schematic view illustrating an image display device producing multiple 2-D images on a full screen sized according to a third embodiment of the present invention.

In FIG. 5, an image display device 300 includes an LCD device 310 and a glass 345 including first and second shutter lenses 350a and 350b. The LCD device 310 has substantially the same structure as that of the first embodiment. The LCD device 310 produces a first image for a left-side eye during a (2N−1)th frame and a second image for a right-side eye during a (2N)th frame. The explanation is focused on the glass 345.

Each of the first and second shutter lenses 350a and 350b of the glass 345 serves as a shutter for selectively transmitting or blocking light. For example, during the (2N−1)th frame, the first shutter lens 350a opens and the second shutter lens 350b is shut such that the user wearing the glass 345 can perceive the first image from the LCD device 310 through the first shutter lens 350a. During the (2N)th frame, the first shutter lens 350a is shut and the second shutter lens 350b opens such that the user wearing the glass 345 can perceive the second image from the LCD device 310 through the second shutter lens 350b. The first and second shutter lenses 350a and 350b are wirelessly synchronized with an operation of the LCD device 310. For the synchronization of the first and second shutter lenses 350a and 350b, a wireless communication unit (not shown) may be required.

Although not shown, each of the first and second shutter lenses 350a and 350b includes first and second substrates and a liquid crystal layer therebetween. A first electrode is formed on the first substrate of each of the first and second shutter lenses 350a and 350b, and a second electrode is formed on the second substrate of each of the first and second shutter lenses 350a and 350b. The alignment direction of the liquid crystal molecules in the liquid crystal layer of each of the first and second shutter lenses 350a and 350b can be controlled by an electric field, which is induced between first and second electrodes of each of the first and second shutter lenses 350a and 350b, across the liquid crystal molecules. As a result, each of the first and second shutter lenses 350a and 350b is controlled to transmit or block the light.

As mentioned above, the LCD device 310 produces the first image for the left-side eye during the (2N−1)th frame and the second image for the right-side eye during the (2N)th frame. Each of the first and second shutter lenses 350a and 350b is synchronized with the LCD device 310. As a result, during the (2N−1)th frame, a shutter of the first shutter lens 350a is turned off and a shutter of the second shutter lens 350b is turned on such that the user perceives the first image through the first shutter lens 350a. On the other hand, during the (2N)th frame, a shutter of the first shutter lens 350a is turned on and a shutter of the second shutter lens 350b is turned off such that the user perceives the second image through the second shutter lens 350b. The first and second images are integrated such that the user can perceive the 3-D image.

In FIG. 6, an image display device 300 includes an LCD device 310 and first and second glasses 360 and 365. The LCD device has substantially the same structure as that of the first embodiment. The LCD device 310 produces a first image for a first user during a (2N−1)th frame and a second image for a second user during a (2N)th frame. The explanation is focused on the first and second glasses 360 and 365.

The first glass 360 includes a first shutter lens 351 for left-side and right-side eyes of the first user, while the second glass 365 includes a second shutter lens 352 for left-side and right-side eyes of the second user. Each of the first and second shutter lenses 351 and 352 of the first and second glasses 360 and 365 serves as a shutter for selectively transmitting or blocking light. The first and second shutter lenses 351 and 352 are wirelessly synchronized with an operation of the LCD device 310. For the synchronization of the first and second shutter lenses 351 and 352, a wireless communication unit (not shown) may be required.

The first and second shutter lenses 351 and 352 has substantially the same structure and function as the first and second shutter lenses 350a and 350b in FIG. 5, respectively. As mentioned above, the LCD device 310 produces the first image for the first user during the (2N−1)th frame and the second image for the second user during the (2N)th frame. Each of the first and second shutter lenses 351 and 352 is synchronized with the LCD device 310. As a result, during the (2N−1)th frame, a shutter of the first shutter lens 351 of the first glass 360 is turned off and a shutter of the second shutter lens 352 of the second glass 365 is turned on such that the first user perceives the first image through the first shutter lens 351. On the other hand, during the (2N)th frame, a shutter of the first shutter lens 351 of the first glass 360 is turned on and a shutter of the second shutter lens 352 of the second glass 365 is turned off such that the second user perceives the second image through the second shutter lens 352. Namely, the first and second users can watch the first and second images with a full screen size at the same time with a single LCD device 310, respectively. One glass is switched to be the glass 345 of FIG. 5, the first glass 360 of FIG. 6 and the second glass 365 of FIG. 6.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An image display system, comprising:
a display device including a (2N−1)th pixel row and a (2N)th pixel row and producing a first image on the (2N−1)th pixel row and a second image on the (2N)th pixel row, wherein N is positive integer;
a patterned retarder at an outer side of the display device and including a first pattern corresponding to the (2N−1)th pixel row and a second pattern corresponding to the (2N) pixel row, wherein a light of the first image is polarized as a first polarized light by the first pattern and a light of the second image is polarized as a second polarized light by the second pattern;
a first polarization film on one of lenses of a glasses and transmitting one of the first and second polarized lights; and
a second polarization film on the other one of the lenses of the glasses and transmitting the other one of the first and second polarized lights.

2. The system according to claim 1, wherein the first polarized light is a left-hand circularly polarized light, and the second polarized light is a right-hand circularly polarized light.

3. An image display system, comprising:
a display device including a (2N−1)th pixel row and a (2N)th pixel row and producing a first image on the (2N−1)th pixel row and a second image on the (2N)th pixel row, wherein N is positive integer;
a patterned retarder at an outer side of the display device and including a first pattern corresponding to the (2N−1)th pixel row and a second pattern corresponding to the (2N)th pixel row, wherein a light of the first image is polarized as a first polarized light by the first pattern and a light of the second image is polarized as a second polarized light by the second pattern;
a first polarization film on both lenses of a first glasses and transmitting one of the first and second polarized lights; and
a second polarization film on both lenses of a second glasses and transmitting the other one of the first and second polarized lights.

4. The system according to claim 3, wherein the first polarized light is a left-hand circularly polarized light, and the second polarized light is a right-hand circularly polarized light.

5. An image display system, comprising:
a display device producing first to Nth images during first to Nth frames, respectively, wherein N is a positive integer;
a polarization modulation panel at an outer side of the display device, a condition of the polarization modulation panel is changed in each frame such that lights of the first to Nth images are changed to be first to Nth polarized lights by the polarization modulation panel;
first to Nth polarization films attached on first to Nth glasses, respectively.

6. The system according to claim 5, wherein the N is one of 2 to 8.

7. The system according to claim 5, wherein the polarization modulation panel includes:
a first electrode on a first substrate;
a second substrate on a second substrate facing the first substrate; and
a liquid crystal layer interposed therebetween and driven by an electric field induced between the first and second substrate.

8. An image display system, comprising:
a display device producing first and second images during first and second frames, respectively;
a polarization modulation panel at an outer side of the display device, a condition of the polarization modulation panel is changed in each frame such that lights of the first and second images are polarized as first and second polarized lights by the polarization modulation panel, respectively;
a first polarization film on one of lenses of a glasses and transmitting one of the first and second polarized lights; and
a second polarization film on the other one of the lenses of the glasses and transmitting the other one of the first and second polarized lights.

9. The system according to claim 8, wherein the first polarized light is a left-hand circularly polarized light, and the second polarized light is a right-hand circularly polarized light.

10. The system according to claim 8, wherein the polarization modulation panel includes:
a first electrode on a first substrate;
a second substrate on a second substrate facing the first substrate; and
a liquid crystal layer interposed therebetween and driven by an electric field induced between the first and second substrate.

11. An image display system, comprising:
a display device producing first and second images during first and second frames, respectively;
a first shutter lens at one side of a glasses, the first shutter being opened during the first frame and being closed during the second frame; and
a second shutter lens at the other one side of the glasses, the second shutter being closed during the first frame and being opened during the second frame.

12. The system according to claim 11, wherein each of the first and second shutter lenses includes:
a first electrode on a first substrate;
a second substrate on a second substrate facing the first substrate; and
a liquid crystal layer interposed therebetween and driven by an electric field induced between the first and second substrate.

13. An image display system, comprising:
a display device producing first and second images during first and second frames, respectively;
a first shutter lens at both sides of a first glasses, the first shutter being opened during the first frame and being closed during the second frame; and
a second shutter lens at both sides of a second glasses, the second shutter being closed during the first frame and being opened during the second frame.

14. The system according to claim 13, wherein each of the first and second shutter lenses includes:
a first electrode on a first substrate;
a second substrate on a second substrate facing the first substrate; and
a liquid crystal layer interposed therebetween and driven by an electric field induced between the first and second substrate.
